(19) United States
(12) Patent Application Publication
(10) Pub. No.: US 2025/0082038 A1
(43) Pub. Date: Mar. 13, 2025

(54) ELECTRONIC ATOMIZATION DEVICE AND CONTROL METHOD THEREOF

(71) Applicant: SHENZHEN FIRST UNION TECHNOLOGY CO., LTD., Shenzhen (CN)

(72) Inventors: Peixia YU, Shenzhen (CN); Ruilong HU, Shenzhen (CN); Zhongli XU, Shenzhen (CN); Yonghai LI, Shenzhen (CN)

(73) Assignee: SHENZHEN FIRST UNION TECHNOLOGY CO., LTD., Shenzhen (CN)

(21) Appl. No.: 18/826,525

(22) Filed: Sep. 6, 2024

(30) Foreign Application Priority Data
Sep. 7, 2023 (CN) 202311160575.5

(51) Int. Cl. A24F 40/57; A24F 40/10; A24F 40/51; A24F 40/53; G05D 23/24

(52) U.S. Cl. CPC A24F 40/57; A24F 40/10; A24F 40/51; A24F 40/53; G05D 23/2401

(57) ABSTRACT

An electronic atomization device and a control method are provided. The electronic atomization device includes a heating element and a battery core. The method includes: controlling the battery core to supply electric power to the heating element at a first power when an inhalation starting signal is obtained, so that a temperature of the heating element increases from an initial temperature to a preset temperature, where the preset temperature does not enable at least one component of the liquid substrate to volatilize; controlling the battery core to supply the electric power to the heating element at a second power, so that the temperature of the heating element increases from the preset temperature to an atomization temperature, where the second power is greater than the first power.

### TECHNICAL FIELD

This application relates to the field of electronic atomization technologies, and in particular, to an electronic atomization device and a control method thereof.

### BACKGROUND

In an existing electronic atomization device, due to relatively large viscosity and poor fluidity of a liquid substrate, during heating and atomization of the liquid substrate, a case that a part of the liquid substrate is overheated, which causes a burnt smell, while other parts remain viscous easily occurs, bringing poor inhalation experience to a user.

### SUMMARY

This application provides an electronic atomization device and a control method thereof, to reduce viscosity of a liquid substrate and improve fluidity of the liquid substrate before the liquid substrate is heated and atomized, so as to avoid a burnt smell and improve inhalation experience of a user.

An aspect of this application provides a control method for an electronic atomization device. The electronic atomization device includes a heating element configured to heat a liquid substrate to generate an aerosol and a battery core configured to supply electric power to the heating element. The method includes:
controlling the battery core to supply the electric power to the heating element at a first power when an inhalation starting signal is obtained, so that a temperature of the heating element increases from an initial temperature to a preset temperature, where the preset temperature does not enable the liquid substrate to volatilize; and
controlling the battery core to supply the electric power to the heating element at a second power, so that the temperature of the heating element increases from the preset temperature to an atomization temperature, where the atomization temperature enables the liquid substrate to volatilize to generate an aerosol, and the second power is greater than the first power.

Another aspect of this application provides an electronic atomization device. The electronic atomization device includes:
a heating element, configured to heat a liquid substrate to generate an aerosol;
a battery core, configured to supply electric power to the heating element; and
a controller, configured to perform the control method for an electronic atomization device.

According to the electronic atomization device and the control method thereof provided in this application, when the electronic atomization device is inhaled, the liquid substrate is first heated at a small power, so that the liquid substrate keeps flowing and does not volatilize, and then the liquid substrate is atomized at a large power to generate an aerosol. In this way, a user does not need to wait for preheating when using the electronic atomization device, a burnt smell is avoided, and inhalation experience of the user is improved.

### BRIEF DESCRIPTION OF THE DRAWINGS

One or more embodiments are exemplarily described with reference to figures in drawings corresponding to the embodiments, but the exemplary descriptions do not constitute a limitation on the embodiments. Elements in the drawings having same reference numerals represent similar elements. Unless otherwise particularly stated, the figures in the drawings are not drawn to scale.

FIG. 1 is a schematic diagram of an electronic atomization device according to an implementation of this application.

FIG. 2 is a schematic diagram of a control method for an electronic atomization device according to an implementation of this application.

FIG. 3 is a schematic diagram of a power curve according to an implementation of this application.

FIG. 4 is a schematic diagram of a temperature curve according to an implementation of this application.

FIG. 5 is a schematic flowchart of controlling the electronic atomization device according to an implementation of this application.

FIG. 6 is another schematic flowchart of controlling the electronic atomization device according to an implementation of this application.

### DETAILED DESCRIPTION

For ease of understanding of this application, this application is described below in more detail with reference to drawings and specific implementations. It should be noted that, when an element is expressed as “being fixed to” another element, the element may be directly on the another element, or one or more intermediate elements may exist between the element and the another element. When an element is expressed as “being connected with” another element, the element may be directly connected with the another element, or one or more intermediate elements may exist between the element and the another element. Terms “up”, “down”, “left”, “right”, “inner”, “outer”, and similar expressions used in this specification are merely used for illustration.

Unless otherwise defined, meanings of all technical and scientific terms used in this specification are the same as those usually understood by a person skilled in the art of this application. The terms used in this specification of this application are merely intended to describe objectives of the specific implementations, and are not intended to limit this application. A term “and/or” used in this specification includes any or all combinations of one or more related listed items.

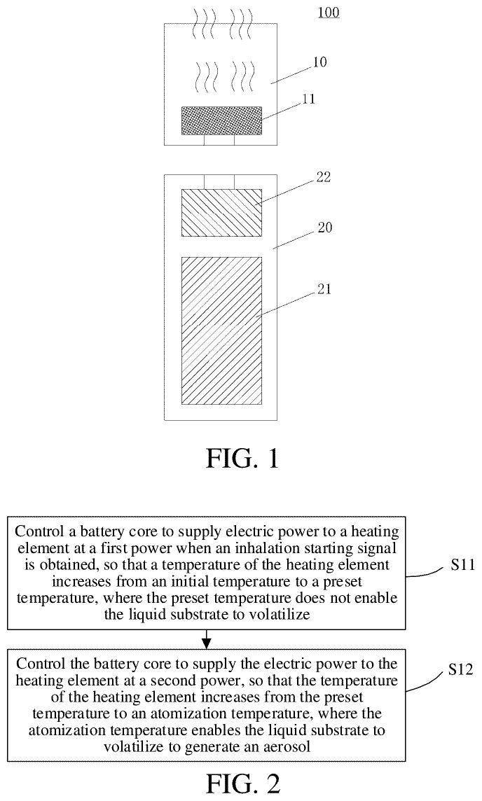

FIG. 1 is a schematic diagram of an electronic atomization device according to an implementation of this application.

As shown in FIG. 1, the electronic atomization device 100 includes an atomizer 10 and a power supply assembly 20. The atomizer 10 is detachably connected to the power supply assembly 20. In another example, the atomizer 10 is non-detachably connected to the power supply assembly 20. In other words, the atomizer and the power supply assembly are integrally formed.

The atomizer 10 includes a liquid storage cavity (not shown) configured to store a liquid substrate and a heating element 11. The heating element 11 atomizes the liquid substrate to generate an inhalable aerosol under an action of electric power supplied by the power supply assembly 20. The heating element 11 includes a resistive material. The resistive material may include but is not limited to a semiconductor, carbon, graphite, metal, a metal alloy, and a composite material formed by a ceramic material and a metal material.

The atomizer 10 further includes a liquid transfer unit. The liquid transfer unit may be made of, for example, cotton fiber, metal fiber, ceramic fiber, glass fiber, porous ceramic, porous glass, or the like. The liquid substrate stored in the liquid storage cavity may be transferred to the heating element 11 through a capillary action.

The power supply assembly 20 includes a battery core 21 and a circuit 22.

The battery core 21 is configured to supply electric power for operating the electronic atomization device 100. The battery core 21 may be a rechargeable battery core or a disposable battery core.

The circuit 22 may control overall operations of the electronic atomization device 100. The circuit 22 is configured to control operations of the battery core 21 and the heating element 11, and control operations of other elements in the electronic atomization device 100. The circuit 22 includes a controller. The controller may adopt a micro controller unit (MCU) or an application-specific integrated chip. The controller is configured to perform a control method for the electronic atomization device 100.

In an example, the electronic atomization device 100 further includes an inhalation sensor. The inhalation sensor includes but is not limited to an air pressure sensor, an airflow sensor, or a commonly referred microphone. The inhalation sensor is configured to detect an inhalation action of a user to generate an inhalation starting signal or an inhalation ending signal.

FIG. 2 is a schematic diagram of a control method for an electronic atomization device according to an implementation of this application. As shown in FIG. 2, the control method includes the following steps.

Step S11: Control the battery core 21 to supply electric power to the heating element 11 at a first power when an inhalation starting signal is obtained, so that a temperature of the heating element 11 increases from an initial temperature to a preset temperature, where the preset temperature does not enable at least one component of the liquid substrate to volatilize.

The first power is used to cause the heating element 11 to be heated from the initial temperature to the preset temperature. The initial temperature may be an ambient temperature or greater than the ambient temperature.

The preset temperature is a temperature range less than a critical temperature. The critical temperature is a temperature close to or less than the boiling point of at least one component of the liquid substrate. At a temperature of the heating element 11 greater than the critical temperature, at least one component of the liquid substrate can volatilize.

The liquid substrate is heated through the heating element 11 provided by the first power, so that the preset temperature keeps the liquid substrate flowing and at least some components of the liquid substrate not to volatilize, and therefore a user does not need to wait for preheating during use.

In an example, the preset temperature is a temperature causing a viscosity of the liquid substrate to be less than 500 cps. When the viscosity of the liquid substrate is less than 500 cps, the liquid substrate can flow to enable the liquid transfer unit or the heating element 11 to absorb the liquid substrate through a capillary force. Further, the preset temperature may be a temperature causing the viscosity of the liquid substrate to be less than 400 cps, 300 cps, 200 cps, or the like.

Step S12: Control the battery core 21 to supply the electric power to the heating element 11 at a second power, so that the temperature of the heating element 11 increases from the preset temperature to an atomization temperature, where the atomization temperature enables the liquid substrate to volatilize to generate an aerosol. The second power is greater than the first power.

The second power is used to cause the heating element 11 to be heated from the preset temperature to the atomization temperature. The atomization temperature is a temperature enabling the liquid substrate to be atomized. In an embodiment, the atomization temperature is a temperature enabling the liquid substrate to generate a maximum atomization amount. In an embodiment, at the second power, the heating element 11 can maintain the temperature thereof at the atomization temperature, thereby ensuring continuous atomization of the liquid substrate. In an embodiment, at the second power, the heating element 11 can maintain the temperature thereof at the atomization temperature, thereby ensuring continuous atomization of the liquid substrate at the maximum atomization amount. In an embodiment, the atomization temperature is in a range of 120° C. to 300° C., preferably in a range of 150° C. to 300° C., preferably in a range of 150° C. to 280° C., preferably in a range of 150° C. to 250° C., and preferably in a range of 150° C. to 200° C. In a specific example, the atomization temperature may be 180° C.

In an example, a ratio of the second power to the first power is in a range of 1.1 to 7, preferably in a range of 1.1 to 5, and preferably in a range of 1.1 to 4. In a specific example, the ratio of the second power to the first power may be 2 or 3.

In an example, the battery core 21 is controlled to stop supplying the electric power to the heating element 11 based on an obtained inhalation ending signal during the control of the battery core 21 to supply the electric power to the heating element 11 at the second power.

It should be noted that, the inhalation starting signal or the inhalation ending signal is preferably generated by the foregoing inhalation sensor. In another example, the inhalation starting signal or the inhalation ending signal may be generated, for example, by a button.

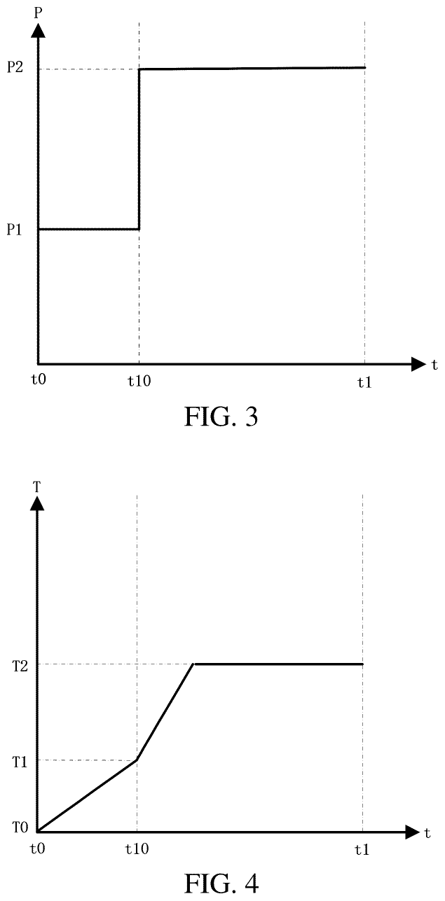

FIG. 3 is a schematic diagram of a power curve according to an implementation of this application. FIG. 4 is a schematic diagram of a temperature curve according to an implementation of this application.

As shown in FIG. 3 and FIG. 4, a duration of an inhalation is t0 to t1.

At the moment to, the controller obtains an inhalation starting signal generated by the inhalation sensor. In this case, the controller controls the heating element 11 to start heating, and controls the battery core 21 to supply electric power to the heating element 11 at a power P1. At the power P1, a temperature of the heating element 11 increases from T0 to T1, so that a liquid substrate keeps flowing and at least some components of the liquid substrate do not volatilize.

In a time period t10 to t1, the controller controls the battery core 21 to supply the electric power to the heating element 11 at a power P2. At the power P2, the temperature of the heating element 11 increases from T1 to T2, so that the liquid substrate is heated and atomized to generate an inhalable aerosol.

In an example, the battery core 21 is controlled to supply the electric power to the heating element 11 at the second power when a duration for controlling the battery core 21 to supply the electric power to the heating element 11 at the first power reaches a first preset time. The first preset time is in a range of 0.1 seconds(s) to 0.3 s.

For example, as shown in FIG. 3, timing is performed from the moment t0. When time reaches (t10-t0), the power of the battery core 21 is changed, so that the electric power is supplied to the heating element 11 at the power P2.

In another example, the temperature of the heating element 11 is monitored during the control of the battery core 21 to supply the electric power to the heating element 11 at the first power. When the temperature of the heating element 11 reaches the preset temperature, the battery core 21 is controlled to supply the electric power to the heating element 11 at the second power.

For example, as shown in FIG. 4, a real-time temperature of the heating element 11 is monitored from the moment to. When the temperature of the heating element 11 reaches T1, the battery core 21 is controlled to supply the electric power to the heating element 11 at the second power.

In a specific implementation, the real-time temperature of the heating element 11 may be detected through a temperature sensor and fed back to the controller. Alternatively, the heating element 11 is constructed as a heating element having a temperature coefficient of resistance. Electrical parameters such as a current and a voltage of the heating element 11 are detected through a detection circuit. The real-time temperature of the heating element 11 is determined by the controller based on the electrical parameters of the heating element 11.

In an example, it is determined whether a time interval between a current inhalation and a previous inhalation exceeds a second preset time when the inhalation starting signal is obtained. The battery core 21 is controlled to supply the electric power to the heating element 11 at the first power if the time interval exceeds the second preset time. The battery core 21 is controlled to supply the electric power to the heating element 11 at a third power if the time interval does not exceed the second preset time.

For successive inhalations, if a time interval between two adjacent inhalations is short, residual heat of the heating element 11 enables the liquid substrate to keep flowing and at least some components of the liquid substrate not to volatilize. In this case, the battery core 21 may be controlled to supply the electric power to the heating element 11 at the third power. The third power is greater than the first power. Generally, the third power is less than or equal to the second power.

For successive inhalations, if the time interval between two adjacent inhalations is long, the battery core 21 may be controlled to supply the electric power to the heating element 11 at the first power and then supply the electric power to the heating element 11 at the second power according to the foregoing steps.

For example, as shown in FIG. 4, the second preset time may be a duration in which the heating element 11 decreases from the temperature T2 to the temperature T1. Generally, the second preset time is in a range of 1 s to 30 s, preferably in a range of 1 s to 25 s, preferably in a range of 1 s to 20 s, preferably in a range of 1 s to 15 s, and preferably in a range of 1 s to 10 s.

In a specific implementation, the second preset time t may be obtained through integration based on an equation dQ=k*(Temp1−Temp2)*dt. K is a heat transfer coefficient, Temp1 is a temperature of the liquid substrate, and Temp2 is an ambient temperature.

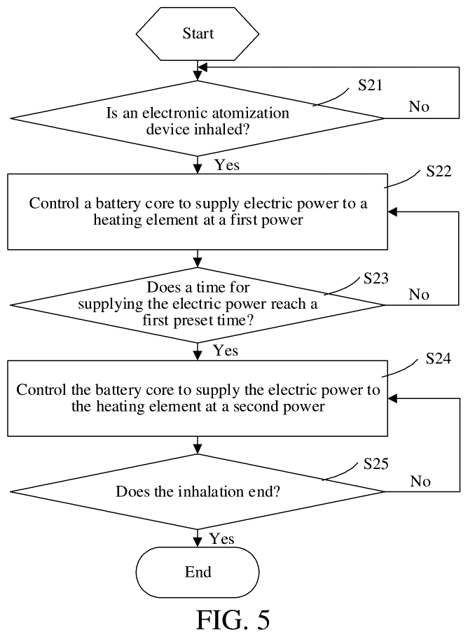

A process of a single inhalation of the electronic atomization device is described below with reference to FIG. 5.
Step S21: Determine whether the electronic atomization device 100 is inhaled; and if the electronic atomization device 100 is inhaled, perform step S22; or otherwise, continue detection and determining.
Step S22: Control the battery core 21 to supply electric power to the heating element 11 at a first power.
Step S23: Determine whether a time for supplying the electric power reaches a first preset time; and if the time for supplying the electric power reaches the first preset time, perform step S24; or otherwise, repeat step S22.
Step S24: Control the battery core 21 to supply the electric power to the heating element 11 at a second power.
Step S25: Determine whether the inhalation ends; and if the inhalation ends, end the control process; or otherwise, perform step S24.

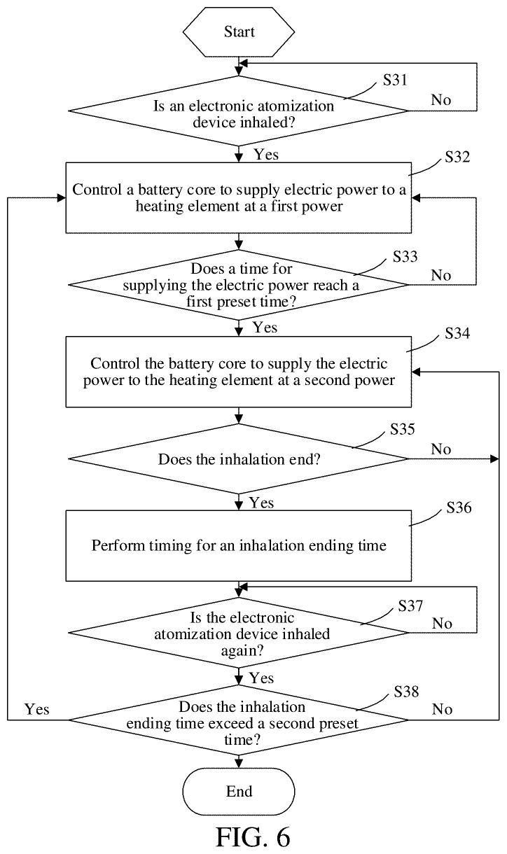

A process of successive inhalations of the electronic atomization device is described below with reference to FIG. 6.
Step S31: Determine whether the electronic atomization device 100 is inhaled; and if the electronic atomization device 100 is inhaled, perform step S32; or otherwise, continue detection and determining.
Step S32: Control the battery core 21 to supply electric power to the heating element 11 at a first power.
Step S33: Determine whether a time for supplying the electric power reaches a first preset time; and if the time for supplying the electric power reaches the first preset time, perform step S34; or otherwise, repeat step S32.
Step S34: Control the battery core 21 to supply the electric power to the heating element 11 at a second power.
Step S35: Determine whether the inhalation ends; and if the inhalation ends, perform step S36; or otherwise, perform step S34.
Step S36: Perform timing for an inhalation ending time. In this step, the timing may be performed by a timer integrated in the controller or a timer independent of the controller.
Step S37: Determine whether the electronic atomization device 100 is inhaled again; and if the electronic atomization device 100 is inhaled again, perform step S38; or otherwise, continue detection and determining or end the control process.
Step S38: Determine whether the inhalation end time exceeds a second preset time; and if the end inhalation time exceeds the second preset time, perform step S32; or if the end inhalation time does not exceed the second preset time, perform step S34.

It should be noted that, the specification of this application and the drawings thereof provide preferred embodiments of this application. However, this application may be implemented in many different forms, and is not limited to the embodiments described in this specification. The embodiments are not used as an additional limitation on the content of this application, and are described to provide more thorough and comprehensive understanding of the disclosure of this application. In addition, the foregoing technical features are further combined to form various embodiments not listed above, which shall be construed as falling within the scope of this application. Further, a person of ordinary skill in the art may make improvements or modifications based on the above descriptions, and all of the improvements and modifications shall fall within the protection scope of the appended claims of this application.

What is claimed is:

1. An electronic atomization device comprising:
a heating element configured to heat a liquid substrate to generate an aerosol;
a battery core configured to supply electric power to the heating element; and
a controller configured to:
control the battery core to supply the electric power to the heating element at a first power when an inhalation starting signal is obtained, so that a temperature of the heating element increases from an initial temperature to a preset temperature, wherein the preset temperature does not enable at least one component of the liquid substrate to volatilize; and
control the battery core to supply the electric power to the heating element at a second power, so that the temperature of the heating element increases from the preset temperature to an atomization temperature, wherein the atomization temperature enables the at least one component of the liquid substrate to volatilize to generate an aerosol, and the second power is greater than the first power.

2. The device according to claim 1, wherein the controller is further configured to control the battery core to supply the electric power to the heating element at the second power when a duration for controlling the battery core to supply the electric power to the heating element at the first power reaches a first preset time.

3. The device according to claim 2, wherein the first preset time is in a range of 0.1 seconds(s) to 0.3 s.

4. The device according to claim 1, wherein:
the temperature of the heating element is monitored during the control of the battery core to supply the electric power to the heating element at the first power; and
the battery core is controlled to supply the electric power to the heating element at the second power when the temperature of the heating element reaches the preset temperature.

5. The device according to claim 1, wherein the preset temperature is a temperature range less than a critical temperature.

6. The device according to claim 1, wherein the preset temperature is a temperature causing a viscosity of the liquid substrate to be less than 500 cps.

7. The device according to claim 1, wherein the controller is further configured to:
determine whether a time interval between a current inhalation and a previous inhalation exceeds a second preset time when the inhalation starting signal is obtained; and
control the battery core to supply the electric power to the heating element at the first power if the time interval exceeds the second preset time.

8. The device according to claim 7, wherein the battery core is controlled to supply the electric power to the heating element at a third power if the time interval does not exceed the second preset time.

9. The device according to claim 1, wherein a ratio of the second power to the first power is in a range of 1.1 to 7.

10. The device according to claim 1, wherein the controller is further configured to:
control the battery core to stop supplying the electric power to the heating element based on an obtained inhalation ending signal during the control of the battery core to supply the electric power to the heating element at the second power.

11. The device according to claim 1, further comprising an inhalation sensor configured to detect an inhalation action of a user to generate an inhalation starting signal or an inhalation ending signal.

12. A control method for an electronic atomization device, wherein the electronic atomization device comprises a heating element configured to heat a liquid substrate to generate an aerosol and a battery core configured to supply electric power to the heating element, the method comprising:
controlling the battery core to supply the electric power to the heating element at a first power when an inhalation starting signal is obtained, so that a temperature of the heating element increases from an initial temperature to a preset temperature, wherein the preset temperature does not enable at least one component of the liquid substrate to volatilize; and
controlling the battery core to supply the electric power to the heating element at a second power, so that the temperature of the heating element increases from the preset temperature to an atomization temperature, wherein the atomization temperature enables the at least one component of the liquid substrate to volatilize to generate an aerosol, and the second power is greater than the first power.

13. The method according to claim 12, wherein:
the battery core is controlled to supply the electric power to the heating element at the second power when a duration for controlling the battery core to supply the electric power to the heating element at the first power reaches a first preset time; and
the first preset time is in a range of 0.1 seconds(s) to 0.3 s.

14. The method according to claim 12, wherein:
the temperature of the heating element is monitored during the control of the battery core to supply the electric power to the heating element at the first power; and
the battery core is controlled to supply the electric power to the heating element at the second power when the temperature of the heating element reaches the preset temperature.

15. The method according to claim 12, wherein the preset temperature is a temperature range less than a critical temperature.

16. The method according to claim 12, wherein the preset temperature is a temperature causing a viscosity of the liquid substrate to be less than 500 cps.

17. The method according to claim 12, further comprising:
determining whether a time interval between a current inhalation and a previous inhalation exceeds a second preset time when the inhalation starting signal is obtained; and
controlling the battery core to supply the electric power to the heating element at the first power if the time interval exceeds the second preset time.

18. The method according to claim 17, wherein the battery core is controlled to supply the electric power to the heating element at a third power if the time interval does not exceed the second preset time.

19. The method according to claim 12, wherein a ratio of the second power to the first power is in a range of 1.1 to 7.

20. The method according to claim 12, further comprising:
controlling the battery core to stop supplying the electric power to the heating element based on an obtained inhalation ending signal during the control of the battery core to supply the electric power to the heating element at the second power.
